(19) United States
(12) Patent Application Publication
(10) Pub. No.: US 2014/0378181 A1
(43) Pub. Date: Dec. 25, 2014

(54) Inline Audio Recording Device

(71) Applicant: Mark Larman, Coral Springs, FL (US)

(72) Inventor: Mark Larman, Coral Springs, FL (US)

(21) Appl. No.: 14/308,080

(22) Filed: Jun. 18, 2014

Related U.S. Application Data
(60) Provisional application No. 61/837,894, filed on Jun. 21, 2013.

(51) Int. Cl. H04M 3/42

(52) U.S. Cl. CPC H04M 3/42221
USPC 455/550.1

(57) ABSTRACT

A device is provided to be used in conjunction with a smart phone said device having an input for receiving a signal from a smart phone, a means of recording all signals transmitted over a telephone call, engine output constructed and arranged to be use with a telephone headset.

### INDEX TO RELATED APPLICATIONS

This application is a non-provisional of and claims benefit to U.S. Provisional Patent Application Ser. No. 61/837,894, filed Jun. 21, 2013 the disclosure of which is incorporated herein by reference in its entirety.

### BACKGROUND OF THE INVENTION

### Field of the Invention

Recording devices have increasingly become more sophisticated. However, devices used in conjunction with today's smart phones have been found to have several drawbacks. Devices are typically not capable of recording telephone calls.

Additionally, if a device is configured to record a telephone call, the device typically does not provide an optimal means for recording an audio file.

The present invention addresses this deficiency.

### SUMMARY OF THE INVENTION

Smartphones have the ability to process audio signals from spoken words as well as audio signals produced by music files. When one plugs a set of headphones into an audio output, the headphones create a certain amount of resistance. This resistance tends to add distortion to the audio signal. Furthermore, if one were to try and utilize a secondary device between the headphones and the audio source, the secondary device likely will impart additional resistance in the transmission of the signal.

The present invention addresses these issues. The device of the present invention is constructed and arranged to receive an audio signal, process the nature of the signal, nature including but not limited to an audio signal of spoken words or an audio signal of a music file, record the input signal, and produce an output.

In one embodiment, the device of the present invention is directly connected to the output of a smart phone. The device is constructed and arranged with an output jack and the user will plug a headphone into the outlet check. The system now comprises: a smart phone, a line from the smart phone to the device of the present invention, a line out from the smart phone to headphones used by a user. In one embodiment, it is contemplated that the device will compensate for signal distortion due to resistance.

In one embodiment, the present invention is a device for real-time recording of audio input, said device comprising:

a first audio input receiver for receiving a first audio input signal;
optionally, a second audio input receiver for receiving an audio input signal
a processor for electronically storing said first audio input signal and, if present, said second audio input signal;
an output for outputting said first audio input signal and, if present, said second audio input signal; and
a sound regulator constructed and arranged to optimize recording characteristics and output characteristics to optimum audio levels.

The first audio input is from a cell phone, smart phone, tablet, other electronic audio source, or combinations thereof.

The first audio input is either directly connected (e.g. hard wired) to the cell phone, smart phone, or other electronic audio source or alternatively is wirelessly connected.

The device to the first audio source creates a connection and imparts a configuration whereby all audio signals of a telephone call are recorded.

The device has a wired output providing real-time delivery of all audio on said telephone call.

The device differentiates between audio of a conversation and audio of a music and optimizes said recording based on a source of said audio input.

The device audio output is to an audio speaker, audio speaker assembly including a microphone, or combinations thereof.

The device is also constructed and arranged to electronically store recorded audio on a non-transitory computer readable medium and selectively play back through audio speakers or transfer as an electronic file to a device associated with a microprocessor for playback of the stored audio file.

The device also has built in microphone for direct recording.

Also contemplated is a system for recording cell phone audio, said system comprising:

a cell phone; and
a device according to the present invention.

In one embodiment, the device is used with video. A user connects a video, for example, but not limited to the HDMI line from a satellite, or cable box and plug it into the device. Then a connection is made from the device into the television. Then the recording could be activated remotely even, imagine an “EASY” like button that sits on the coffee table you just hit to record when something is showing that you want. Then you'd never have to worry about deleting your favorite shows or movies because your DVR ran out of storage capacity.

### BRIEF DESCRIPTION OF THE SEVERAL VIEWS OF THE DRAWING

FIG. 1 is a perspective view of one embodiment of the present invention.

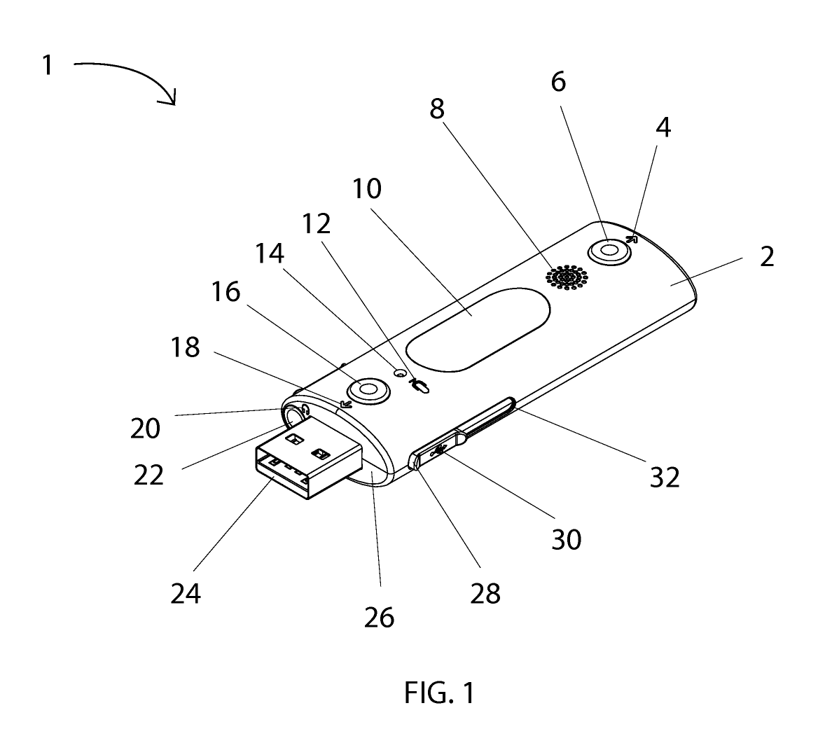

FIG. 2 is a plan view of the top end of one embodiment of the present invention.

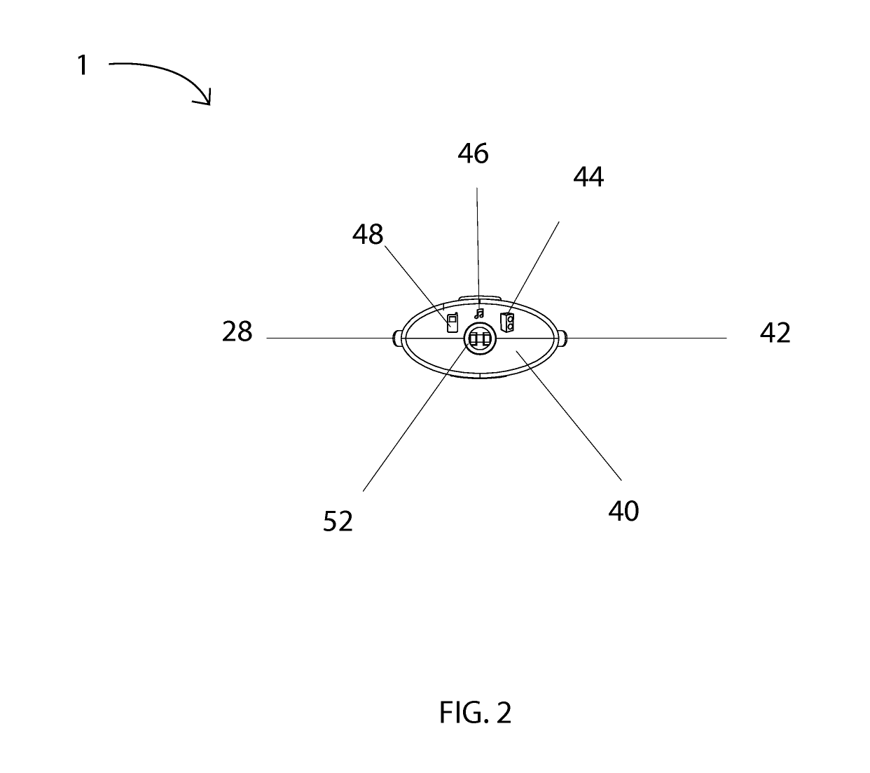

FIG. 3 is a plan view of the bottom end of one embodiment the present invention.

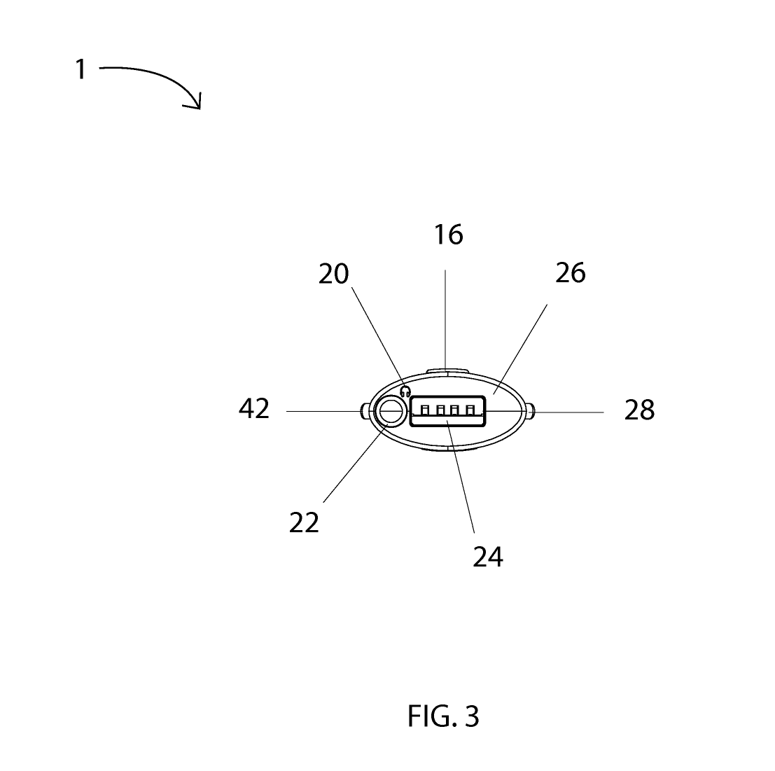

FIG. 4 is a plan view of the back surface of one embodiment the present invention.

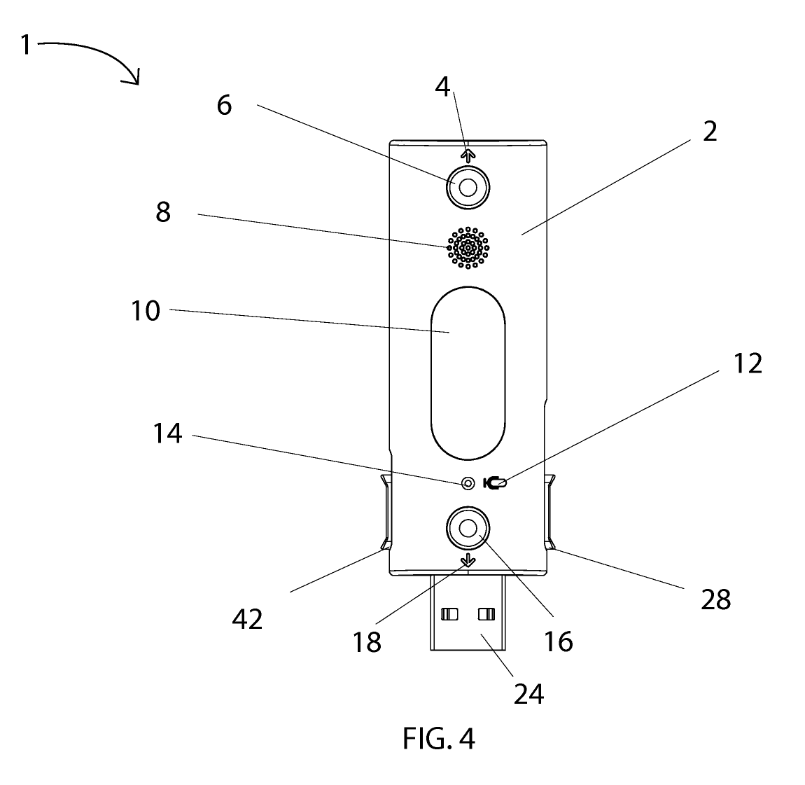

FIG. 5 is a plan view of the front of one embodiment of the present invention.

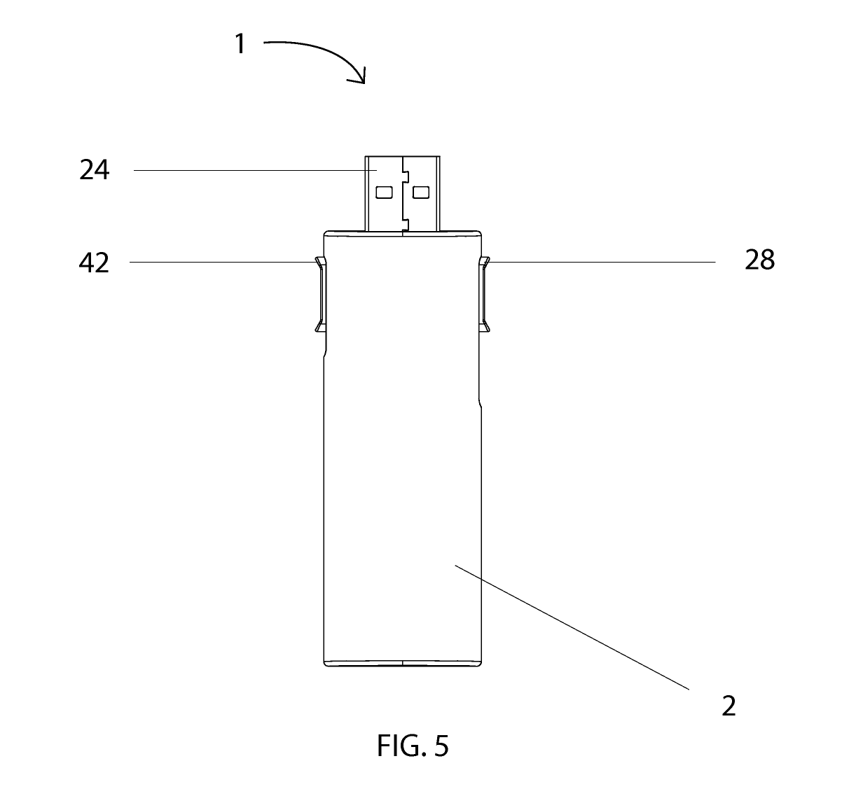

FIG. 6 is a first side view of one embodiment of the present invention.

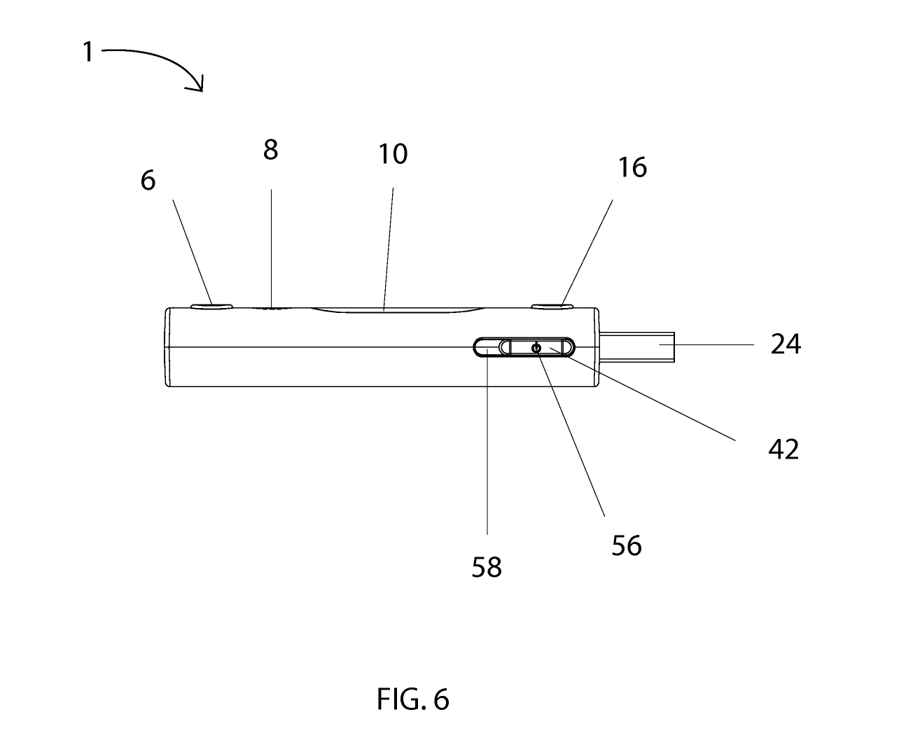

FIG. 7 is a second side view of one embodiment of the present invention.

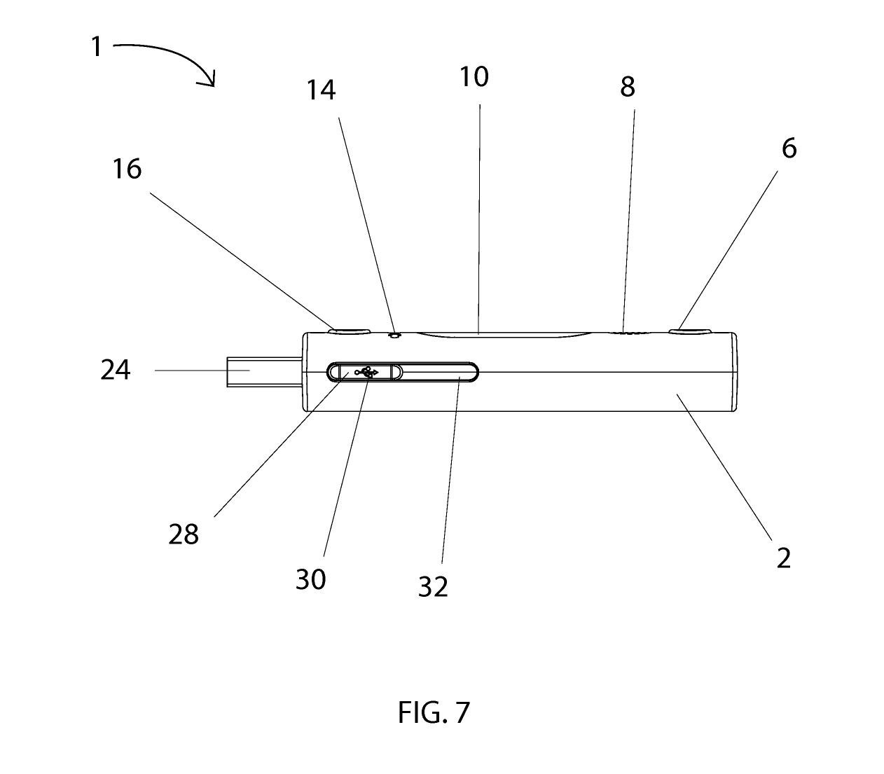

FIG. 8 is a perspective view of internal components of one embodiment of the present invention.

FIG. 9 is a plan view of internal components of one embodiment of the invention.

FIG. 10 is a plan view of internal components of one environment of the present invention.

FIG. 11 is a side view of internal components of one embodiment of the present invention.

FIG. 12 is a side view of internal components of one embodiment of the present invention.

FIG. 13 shows an embodiment of a system according to the present invention.

### DETAILED DESCRIPTION OF THE PREFERRED EMBODIMENT

The present invention provides a device constructed and arranged to interact with an audio output of a source. The device provides for transmission of an audio signal from the source. The term “source” as used herein, is any source that creates and provides an output of an audio signal. Source includes, but is not limited to, a cell phone, smartphone, MP3 player, digital audio player, CD and/or DVD player, stereo, and combinations thereof. As used herein, cell phone encompasses cell phones, smart phones, tablets, and the like.

When transmitting electrical audio signals across a cable, most sophisticated equipment uses a balanced signal to provide protection against any external noise picked up along the length of the cable.

However, most consumer or older equipment uses an unbalanced signal, and this provides less protection against noise interference.

Unbalanced Signal

An unbalanced signal consists of an electrical signal sent along one wire alongside an earth wire to eliminate ground loops between the components at each end of the connection that can introduce noise.

Balanced Signal

A balanced signal consists of a hot (positive) wire, a cold (negative) wire and the same source signal is fed twice, however the second signal is an inverted version of the original (the polarity is inverted from +ve to −ve). At the receiving end, the second signal is inverted back to be identical to the source and any noise that has been added to the signal along the cable is cancelled out when the two signals are summed together.

This noise reduction method of ‘balancing’ when transferring an analogue audio signal via cable is not a perfect solution, which is why an earth or shield wire is used as well to prevent ground loops between connecting components.

Conversely, instead of a balanced mono signal, the twisted pair of wires in an analogue audio cable can be used to send two separate left and right audio signals to create a full stereo channel.

The present invention, in one embodiment, provides an in-line device that evaluates the signal, and provides an output based on appropriate input of unbalanced or balanced input.

For reference only, and not intended to be limiting, in one embodiment, the present invention is constructed and arranged to be used in conjunction with an iPhone.

A typical iPhone exhibits the following output characteristics:

Output Voltage

| Load | 0 DBFS @ 1 kHz | |
|---|---|---|
| 200 kΩ | 1.0158 | V |
| 600 Ω | 1.0075 | V |
| 37.5 Ω | 916.3 | mV |

Output Source Impedance
4.5 Ω.
Output Noise Levels
−106.8 dBV, A-weighted, playing zeroes (silence).
−116 dBV, A-weighted, idle.

When utilizing headphones, there is resistance in the transmission of the audio signal and harmonic distortion occurs.

Most commercial headphones impart 32Ω resistance on the output signal. If one runs a line from the iPhone, to an inline device and a headphone output from the inline device, there will be an increase in resistance and distortion.

The device of the present invention receives the audio input, provides means of duplicating said input, and means of output of the duplicated input.

In an embodiment where the device is connected to a phone, the device is configured to record a call in real-time while the output is provided for one party on the telephone call.

In one embodiment, the device as a means for receiving audio input, a means for recording said input, and an input and/or input output means. In the embodiment where input/output means is used, the device, when connected in-line to a phone, can record all audio transmitted on the call.

In another embodiment, the device is constructed with audio playback and an audio output of recorded input. The audio output is delivered to an external speaker, an audio output jack, a USB port, or combinations thereof.

In one embodiment, use of the device is contemplated as follows:

A user is provided with a device;

the device is connected to an audio output source;
the device is powered on;
a recording mode is initiated on the device;
an output signal is directed from said audio output into the device audio input;
audio signal received in the device audio input is recorded;
a device audio output delivers an audio signal from the device contemporaneously with the recording.

In one embodiment, the input is received by direct connection (i.e. a wired delivery)

In one embodiment, the output is delivered by direct connection.

In the embodiment where the device records a phone call, the device is constructed and arranged to record all audio signals transmitted during the call.

In one embodiment, telephone headsets that include speakers and a microphone are contemplated to be used in the present invention. The device according to this embodiment will transmit input from a users microphone input back through the device and into the initial telephone audio source. In one configuration, the device selectively records input. One contemplated arrangement provides two recording button actuators. A first recording button actuator will record only from the audio source. The second recording button actuator will record input from a microphone. In this configuration, if a person is listening to music, only the music from the audio source is recorded and no input from a headset/microphone is recorded.

In one embodiment, the “in-line” arrangement is accomplished by wireless connectivity. A wireless connection is established between the audio source and the device of the invention, and between the device and a headset or headset/microphone. Additionally, the arrangement is contemplated with a combination of wireless and wired connection. A wired connection from the audio source to the device of the invention and a wireless connection to a headset or headset/microphone or a wireless connection from the audio source to the device of the invention and a wired connection to a headset or headset/microphone are also contemplated as part of the present invention.

In one embodiment, the device of the invention includes a USB connector for transfer of data from the device to another computer readable medium. Additionally, it is possible that transfer of data occurs wirelessly.

In one embodiment the present invention includes a device 1 with a main body housing 2 having indicia 4 disposed thereon and first actuation button 6 and second actuation button 16. Body 2 further has incorporated there with a display screen cover 10 at least one opening 8 positioned such that sound from audio speaker 88 emanates therethrough. A microphone cavity 14 having microphone icon 12 placed in close proximity is positioned such that sound travels from the exterior of the device to an internal microphone 90 positioned within main body 2 and in close proximity to microphone cavity 14. Main body 2 further includes a first jack 22 and headphone icon 20 positioned next to receiving jack 22. In a preferred embodiment, first jack 22 is an input/output jack for transmitting audio signals as is known and referred to as a “headphone jack.” Further incorporated their width is a USB connector 24 on front surface 26 of main body 2. Channel 32 has positioned there in sliding position switch 30, with a leverage curved edge 28, whereby sliding position switch 30 is associated with USB connector 24 and provides mechanical support for extension and retraction of USB connector 24 outward from body 2 and retraction within the periphery of body 2 with the movement of sliding positions switch 30.

Surface 40 has positioned there on and second connection jack 52 and speaker icon 44 music icon 46 and cell phone icon 48 disposed on a surface 40. Actuator 42 is constructed and arranged to initiate power to the device of the present invention and subsequently ceased power and terminate electrical functional operation. A second jack 52 is on surface 40.

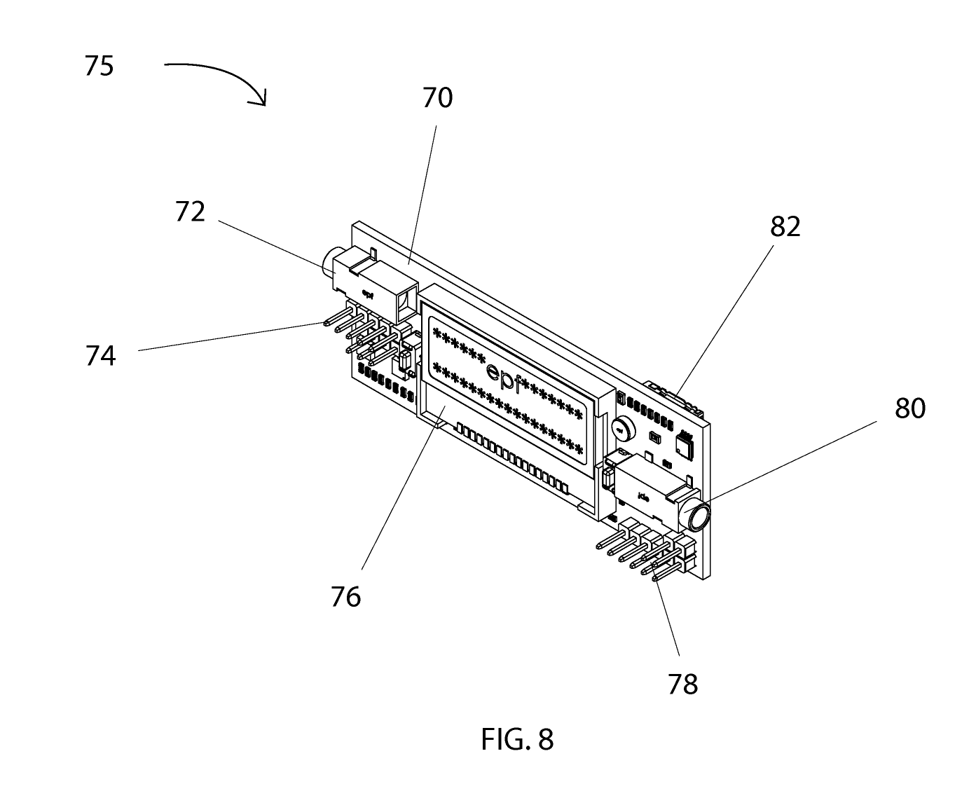

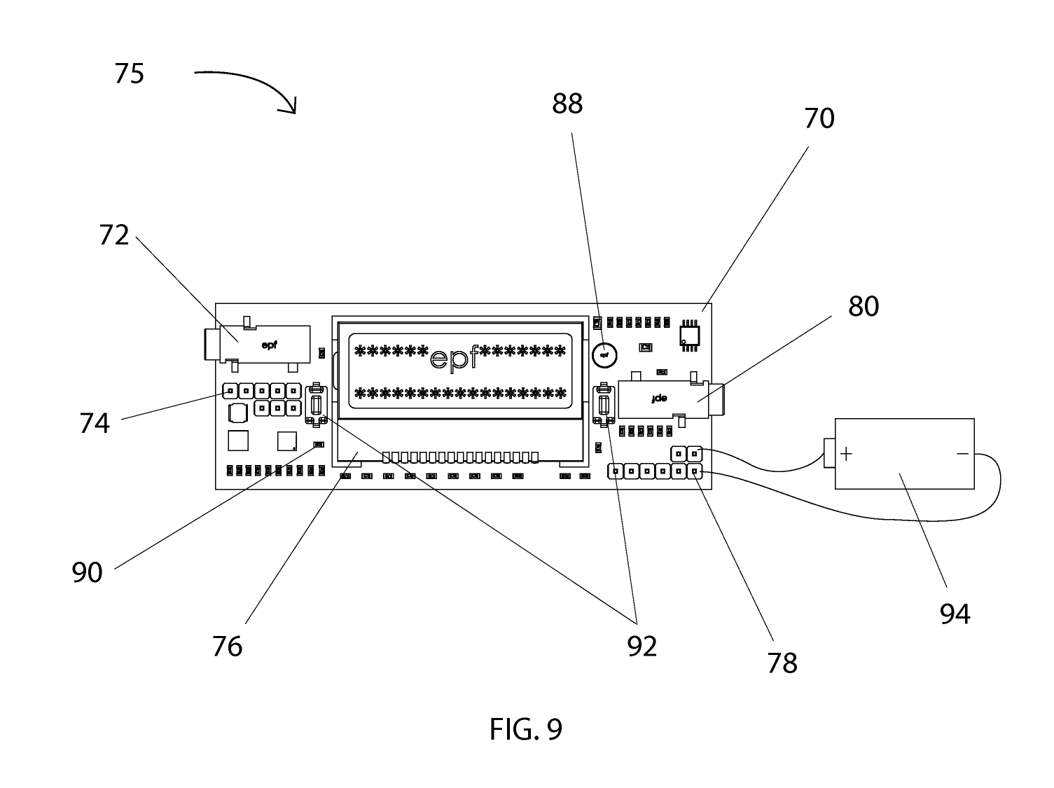

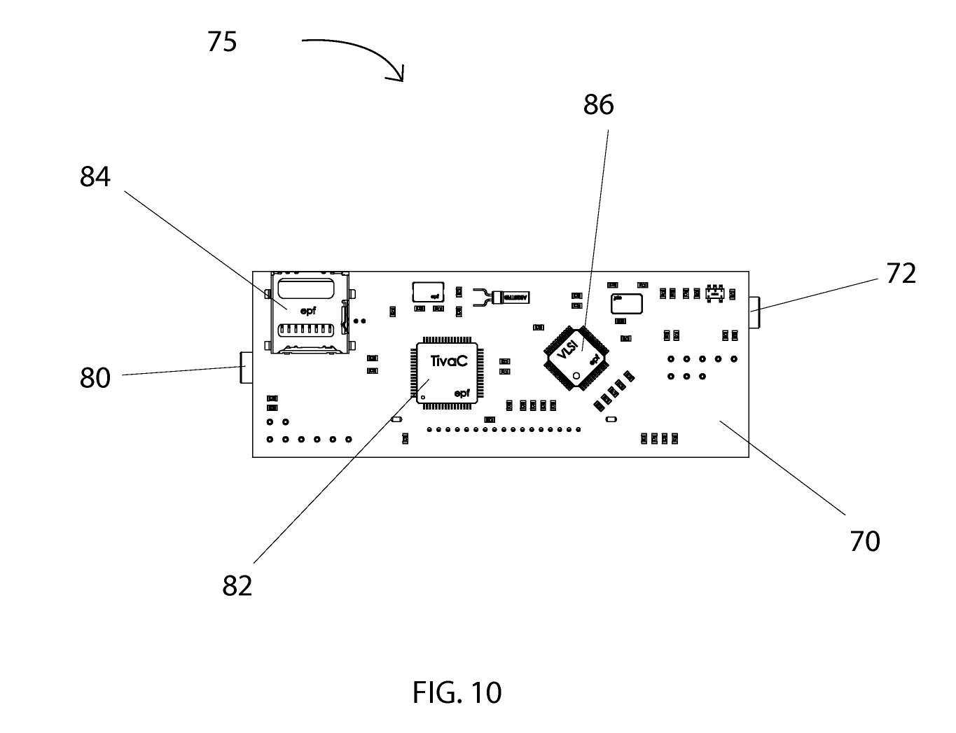

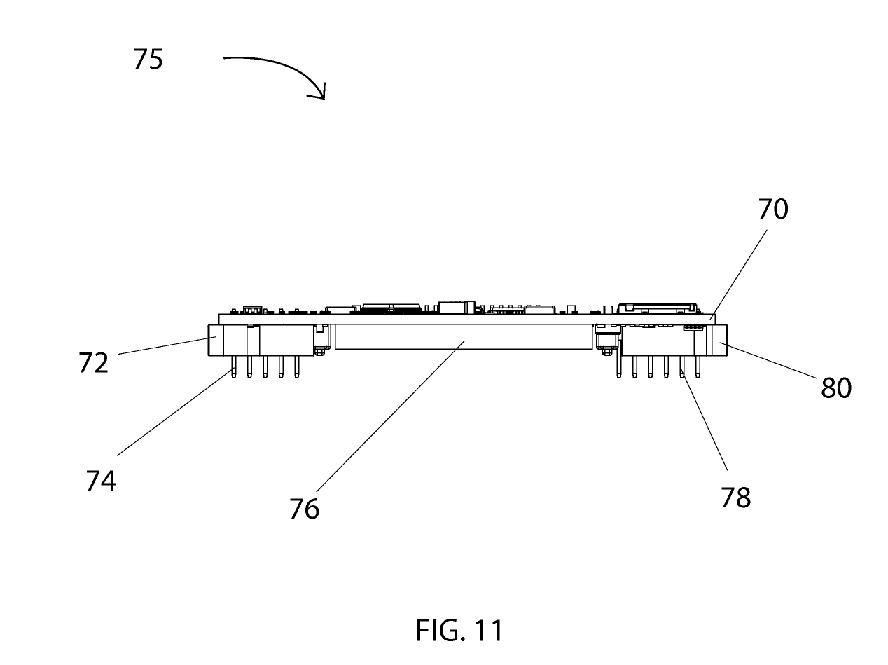

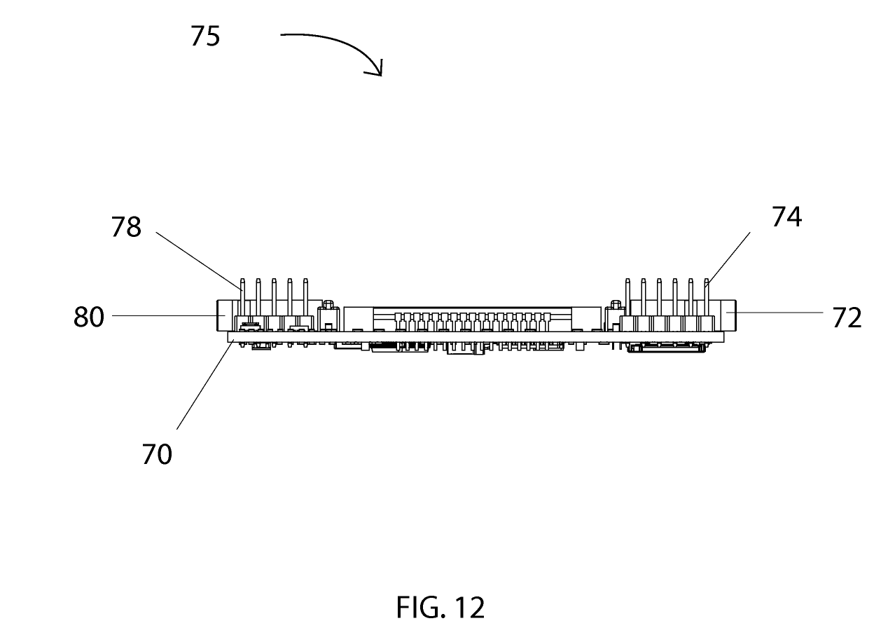

As best seen in FIGS. 8-12, a PCB main board 70 has first audio jack connection 72 that includes first audio jack 22 and USB connectors 74 that interact with USB connector 24. Screen 76 is positioned next to screen cover 10 such that screen 76 is viewable on the outside of the device. PCB main board 70 further includes second audio jack connection 80 that includes second audio jack 52. A battery 94 (not shown actual size) is selected based on appropriate size an electrical characteristics.

PCB main board 70 further includes microprocessor 82 memory card 84 and VLSI-MP3 encoder 86.

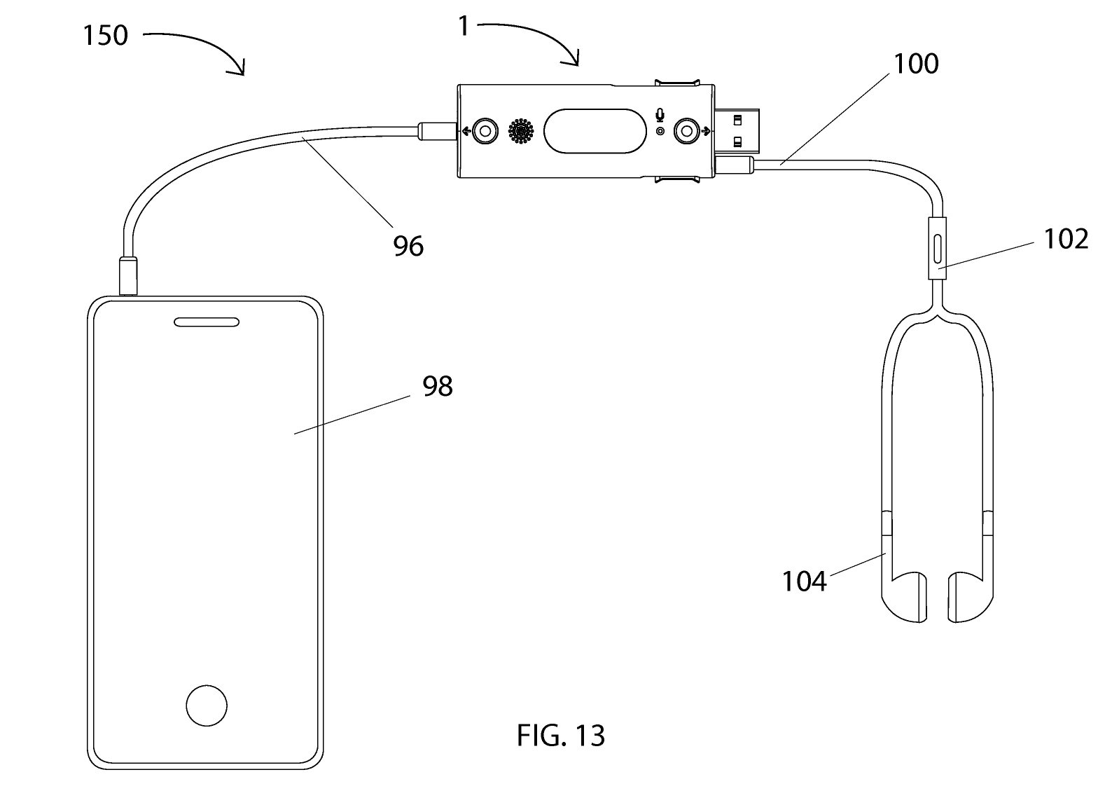

The invention includes a system 150, as shown in FIG. 13, using the device 1 of the invention whereby a phone 98 is connected by phone connection cable 96 to device 1 and audio input/output cable 100 is connected to audio input/output assembly having at least one microphone 102 and speakers 104.

In use, the user will connect a phone to second jack 52 and headphone/microphone assembly to first connection jack 22. The user selectively controls the recording features of device 1.

Initiating first actuator 6 will selectively record from microphone input from a microphone 102 connected to assembly 155. First actuator 6 is constructed and arranged to record input from either or both of microphone 102, internal microphone 90, or to “silence” the microphone input to device 1. Second actuator 16 is constructed and arranged to record either or both of audio from phone 98 and/or audio from microphone 90.

The microprocessor is configured to control the selective functions of device 1 and provide for recording and output of recording on demand. The output is selectively configurable to a playable audio file including, but not limited to files in .mp3, .mp4, .wav, and the like. Although the figures demonstrate an embodiment utilizing a USB port, it is further contemplated that the device be configured for wireless transfer of stored files.

In one embodiment, the device is constructed to be embedded and/or unitary with a headphone or speaker or other audio playing device including bluetooth where a user can actuate a start button on the device to start the recording. In this embodiment, the unitary unit is configurable to operate wirelessly and still accomplish the recording capability of the device and system as set forth herein. Further, as stated herein, an audio file is electronically storable and output on demand. The unitary device would plug into a computer for download or transfer files electronically via USB connection or other appropriate transfer avenue including, but not limited to, wireless file transfer.

Once a user connects phone 98, microphone 102, and speakers 104 in any desired combination, the user selects which recording sequence to initiate. Screen 76 is configured to proved indicia and information as to the recording, playback, storage, and combinations thereof.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A device for real-time recording of audio input, said device comprising:
a first audio input receiver for receiving a first audio input signal;
optionally, a second audio input receiver for receiving an audio input signal
a processor for electronically storing said first audio input signal and, if present, said second audio input signal;
an output for outputting said first audio input signal and, if present, said second audio input signal; and
a sound regulator constructed and arranged to optimize recording characteristics and output characteristics to optimum audio levels.

2. The device of claim 1 wherein said first audio input is from a cell phone or smart phone.

3. The device of claim 2 wherein said device is directly connected to said cell phone or smart phone.

4. The device of claim 2 wherein said device is wirelessly connected to said cell phone or smart phone.

5. The device of claim 3 wherein said direct connection imparts a configuration whereby all audio signals of a telephone call are recorded.

6. The device of claim 4 having a wired output providing real-time delivery of all audio on said telephone call.

7. The device of claim 2 wherein said device differentiates between audio of a conversation and audio of a music and optimizes said recording based on a source of said audio input.

8. The device of claim 1 wherein said output is to an audio speaker.

9. The device of claim 1 wherein said output is to an audio speaker assembly including a microphone.

10. The device of claim 1 wherein said device has built in microphone for direct recording.

11. A system for recording cell phone audio, said system comprising:
a cell phone; and
a device according to claim 1.
